(19) United States
(12) Patent Application Publication
(10) Pub. No.: US 2007/0065797 A1
(43) Pub. Date: Mar. 22, 2007

(54) System and method of preparing for essay examinations

(76) Inventor: Ross Elgart, Deray Beach, FL (US)

Correspondence Address: Peter M. Midgley;HOLLAND & MIDGLEY, LLP, PO Box 1840, Boise, ID, 83701-1840, US

(21) Appl. No.: 11/230,996

(22) Filed: Sep. 20, 2005

(51) Int. Cl. G09B 3/00; G09B 7/00

(52) U.S. Cl. 434/322

(57) ABSTRACT

A computer learning system includes a database containing one or more sample essay questions and model answers prepared in advance by qualified instructors. The system assists a user in preparing for an essay examination by presenting the user with a sample essay question and prompting the user to identify an issue raised by the essay question until the user correctly identifies an issue raised by the essay question. The user is then enabled to provide a partial response related to the identified issue and to conduct a self-evaluation as to whether the partial response is correct by comparing the partial response to a partial model answer. Once the user has completed a question, the user's complete response, which combines the user's partial responses and organizes them by issue, is displayed and the user can compare the complete response to a complete model answer, which includes the partial model answers, organized by issue.

### BACKGROUND

This disclosure relates generally to the field of computer learning systems and, more particularly, to computer learning systems configured to assist users preparing for essay examinations.

Computer learning systems are used by students in many fields of study. These systems are often used to simulate testing conditions or to provide students with immediate feedback as to whether they are adequately learning certain material based on the students' responses to selected questions. Due to these and other advantages over traditional study techniques, computer learning systems are becoming increasingly popular and enjoying increasingly widespread use among students and teachers.

Many computer learning systems include information databases organized as a series of question-answer units called “items.” The items are frequently limited to true/false, multiple choice, or other objective types of questions, because student responses to these types of questions can be readily evaluated by a computer. However, short-answer and essay items are not widely used by computer learning systems because the great variation and open-ended nature of the responses make it difficult to perform automated evaluations of the responses.

### BRIEF DESCRIPTION

The above-mentioned limitations associated with conventional computer learning systems are addressed by embodiments of the present invention and will be understood by reading and studying the following specification.

In one embodiment, a method of assisting a user to prepare for an essay examination comprises presenting the user with an essay question and prompting the user to identify an issue raised by the essay question until the user correctly identifies an issue raised by the essay question. The method further comprises enabling the user to provide a partial response to the essay question, the partial response being related to the identified issue, and enabling the user to evaluate whether the partial response is correct by comparing the partial response to a partial model answer related to the identified issue. The method further comprises displaying the user's complete response to the essay question, the complete response comprising a plurality of the user's partial responses organized by issue, and enabling the user to compare the user's complete response to a complete model answer comprising a plurality of partial model answers organized by issue.

In another embodiment, a database is configured to cooperate with an examination module executed by a processor to assist a user in preparing for an essay examination. The database comprises at least one sample essay question and a list of possible issues raised by each sample essay question, wherein the list of possible issues includes at least one incorrect answer. The database further comprises a plurality of partial model answers to each sample essay question, wherein each partial model answer relates to an issue raised by the corresponding sample essay question. The database further comprises a complete model answer to each sample essay question, wherein each complete model answer comprises the plurality of partial model answers to the corresponding sample essay question, organized by issue.

Other embodiments are described and claimed.

### DRAWINGS

FIG. 1 is a block diagram of a general-purpose computer system in which a system for preparing for essay examinations can operate.

FIG. 2 is a flow chart illustrating an exemplary process performed by the examination module shown in FIG. 1.

FIG. 3 illustrates one embodiment of a sample screen displaying a selected essay question that may be shown to the user.

FIG. 4 illustrates one embodiment of a sample screen with a list of possible issues raised by a given essay question that may be displayed to the user.

FIG. 5 illustrates one embodiment of a sample screen with the USER ANSWER field enabled.

FIG. 6 illustrates one embodiment of a sample screen displaying a complete answer.

Like reference numbers and designations in the various drawings indicate like elements.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical, and electrical changes may be made without departing from the spirit and scope of the present invention. The following detailed description is, therefore, not to be taken in a limiting sense.

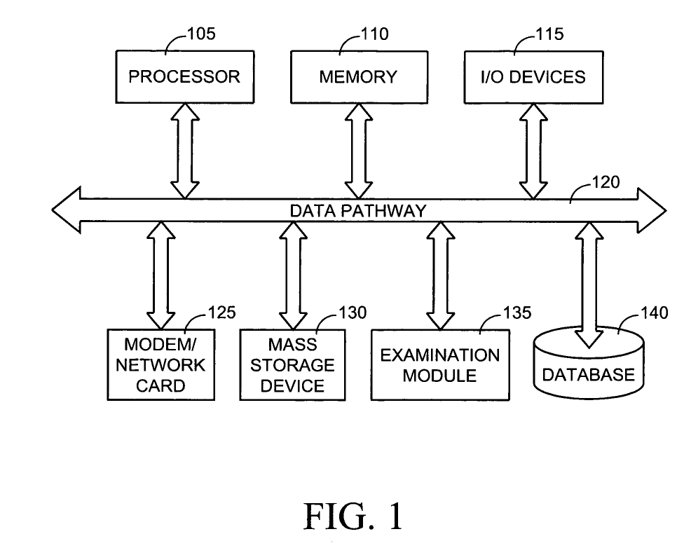

FIG. 1 is a block diagram of a general-purpose computer system 100 in which a system for preparing for essay examinations can operate. The computer system 100 generally comprises a processor 105, a memory 110, and one or more input/output devices 115 interconnected by at least one data pathway, or data bus, 120.

In operation, the processor 105 accepts instructions and data from the memory 110 and performs various calculations. In some embodiments, the processor 105 includes an arithmetic logic unit (ALU) that performs arithmetic and logical operations. The processor 105 may also include a control unit that extracts instructions from the memory 110 and decodes and executes them, calling on the ALU when necessary.

In some embodiments, the memory 110 includes a random-access memory (RAM) and a read-only memory (ROM). The memory 110 may also include other types of memory, such as, for example, programmable read-only memory (PROM), erasable programmable read-only memory (EPROM) and electrically erasable programmable read-only memory (EEPROM). The memory 110 preferably contains an operating system, which executes on the processor 105 and performs basic tasks, such as, for example, recognizing input, sending output to output devices, keeping track of files and directories and controlling various peripheral devices.

The I/O devices 115 generally enable a user to interact with the computer system 100. In some embodiments, the I/O devices 115 comprise a variety of input devices, such as, for example, a keyboard, mouse, etc. that enable the user to enter data and instructions into the computer system 100. The I/O devices 115 also often comprise a variety of output devices, such as, for example, a display, printer, speakers, etc. that allow the user to perceive what the computer has accomplished.

In the illustrated embodiment, the computer system 100 comprises a modem or network card 125 that enables the computer system 100 to access other computers and resources on a network. In addition, the computer system 100 comprises a mass storage device 130 that allows the computer system 100 to permanently retain large amounts of data. The mass storage device 130 may comprise any suitable disk drive, such as, for example, a floppy disk drive, hard disk drive, optical disk drive, tape drive, etc.

In some embodiments, the computer system 100 may comprise all or only some of the components illustrated and described above, in a wide variety of combinations or subcombinations, as well-understood by those of ordinary skill in the art. The computer system 100 may also include many well-known components that are not illustrated or described above. In addition, the computer system 100 can take the form of a wide variety of devices, such as, for example, a personal computer (e.g., desktop computer, laptop computer, etc.), workstation, hand-held digital computer, personal digital assistant computer, mini-computer, mainframe computer, supercomputer, etc.

In the illustrated embodiment, the computer system 100 comprises an examination module 135 and a database 140. As described in more detail below, the database 140 contains at least one sample essay question and model answer prepared in advance by one or more qualified instructors, such as, for example, teachers, professors, commentators, teachers' assistants, advanced students, tutors, etc. In some embodiments, the examination module 135 comprises a software module, which can be implemented using any suitable computer programming language or script. In addition, the database 140 can be implemented using a wide variety of well-known database tools, such as, for example, SQL, Microsoft Access, FoxPro, etc.

In some embodiments, the database 140 is stored in the mass storage device 130. The examination module 135 can also be stored in the mass storage device 130 and, upon user request, loaded into the memory 110 and executed by the processor 105. In operation, the examination module 135 assists the user to prepare for an essay examination, as described below.

As will be appreciated, the examination module 135 can be used by students in any field of study in which essay examinations are administered. It is particularly well-suited for use in fields involving issue identification or problem diagnosis, such as, for example, law, medicine, engineering, system repair (e.g., automotive repair), etc. For purposes of illustration in this disclosure, the examination module 135 will be described primarily with reference to law students preparing for essay examinations administered in law school or on a bar examination, for example.

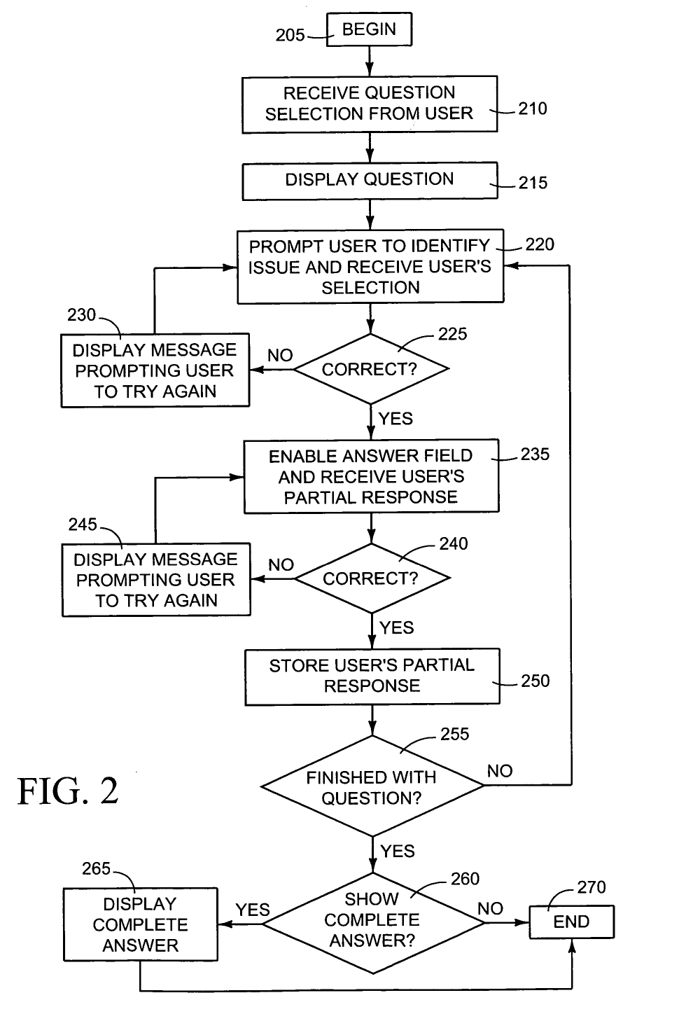

FIG. 2 is a flow chart illustrating an exemplary process 200 performed by the examination module 135. In a first step 205, the process 200 begins. In a next step 210, an input is received from the user selecting a sample essay question for review. In a step 215, the selected essay question is displayed to the user.

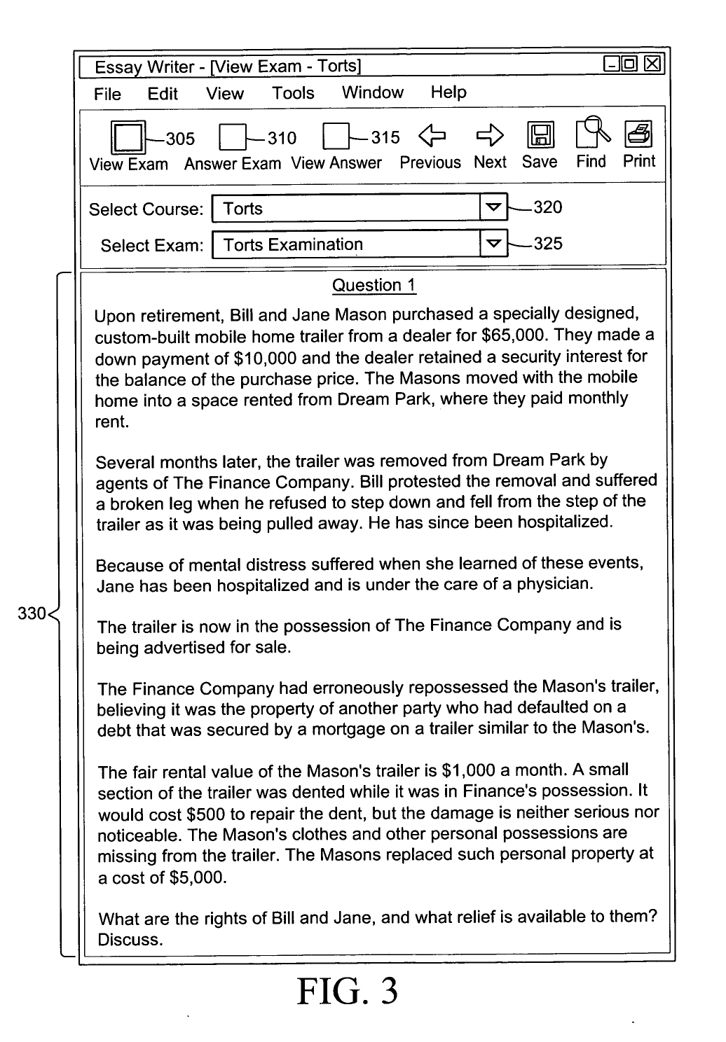

For example, FIG. 3 illustrates one embodiment of a sample screen 300 displaying a selected essay question that may be shown to the user in step 215. In the illustrated embodiment, the screen 300 comprises a VIEW EXAM button 305, an ANSWER EXAM button 310, and a VIEW ANSWER button 315. As illustrated, when the VIEW EXAM button 305 is activated, the screen 300 comprises a SELECT COURSE box 320, a SELECT EXAM box 325, and a display frame 330. In some embodiments, the SELECT COURSE box 320 and the SELECT EXAM box 325 comprise drop-down menus populated with information stored in the database 140. Once the user has selected a course and examination for review, an essay question from the selected examination is displayed in the display frame 330.

Referring again to FIG. 2, after the essay question has been displayed, the user is prompted, in a step 220, to identify at least one issue raised by the question and the user's response is received. In some embodiments, this process involves selecting an issue from a predetermined list of possible issues presented by the question.

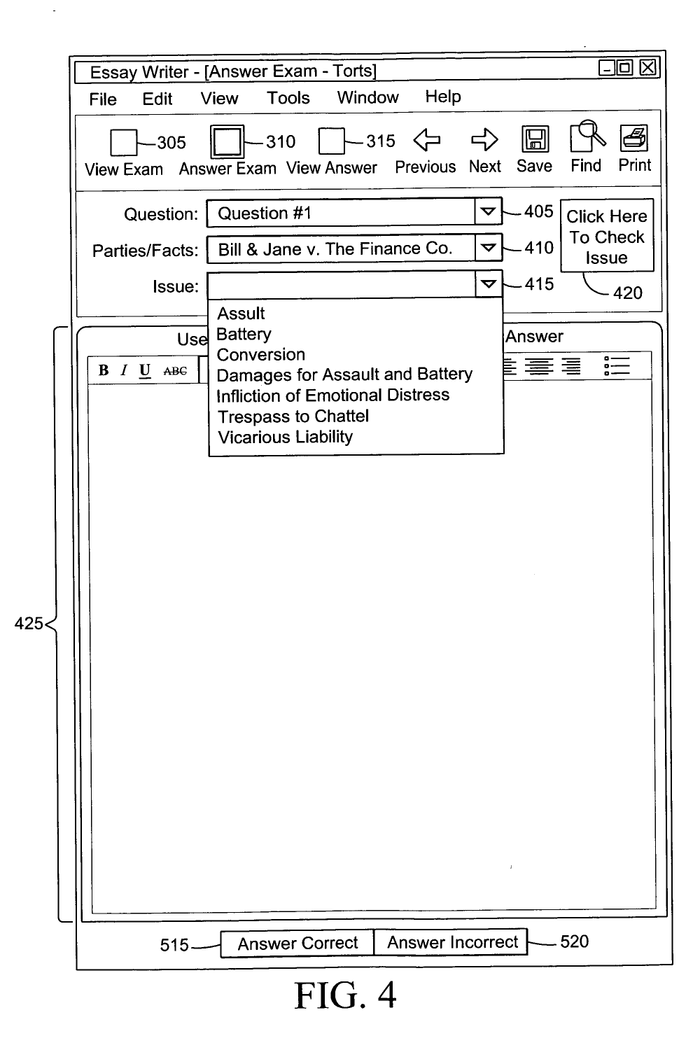

For example, FIG. 4 illustrates one embodiment of a sample screen 400 with a list of possible issues raised by a given essay question that may be displayed to the user. In the illustrated embodiment, when the ANSWER EXAM button 310 is activated, the screen 400 comprises a QUESTION selection box 405, a PARTIES/FACTS selection box 410, an ISSUE selection box 415, a CHECK ISSUE button 420, and a display frame 425. In some embodiments, the PARTIES/FACTS selection box 410 does not exist or the PARTIES/FACTS selection box 410 and the ISSUE selection box 415 are combined into a single selection box.

In some embodiments, the QUESTION selection box 405, the PARTIES/FACTS selection box 410, and the ISSUE selection box 415 comprise drop-down menus populated with information stored in the database 140. In the illustrated embodiment, the user has already made selections from the drop-down menus of the QUESTION selection box 405 and the PARTIES/FACTS selection box 410, and is presented with a list of possible issues (e.g., “Assault,” “Battery,” etc.) raised by the essay question in the drop-down menu of the ISSUE selection box 415. The list of issues preferably includes one or more incorrect answers intended to test the user's ability to correctly identify the actual issues raised by the question. An incorrect answer may comprise an issue that is not raised by the question or it may comprise an issue that is incorrect only for the selected question and parties, i.e., an incorrect combination of selections from the QUESTION selection box 405, PARTIES/FACTS selection box 410, and ISSUE selection box 415. In some embodiments, the list of issues, including the incorrect answers, is created in advance by one or more qualified instructors and stored in the database 140.

Once the user has selected an issue from the list, the user can activate the CHECK ISSUE button 420 to determine whether the selected issue is correct. Referring again to FIG. 2, this process is illustrated in step 225, in which a determination is made as to whether the issue identified by the user is correct. If the selected issue is incorrect, a message is displayed, in a step 230, notifying the user that the issue is incorrect and prompting the user to try again. These steps are repeated until the user correctly identifies an issue raised by the question. Then, in a step 235, a user answer field is enabled, and the user is permitted to provide a partial response to the essay question. The partial response preferably relates to the issue correctly identified by the user, as described above.

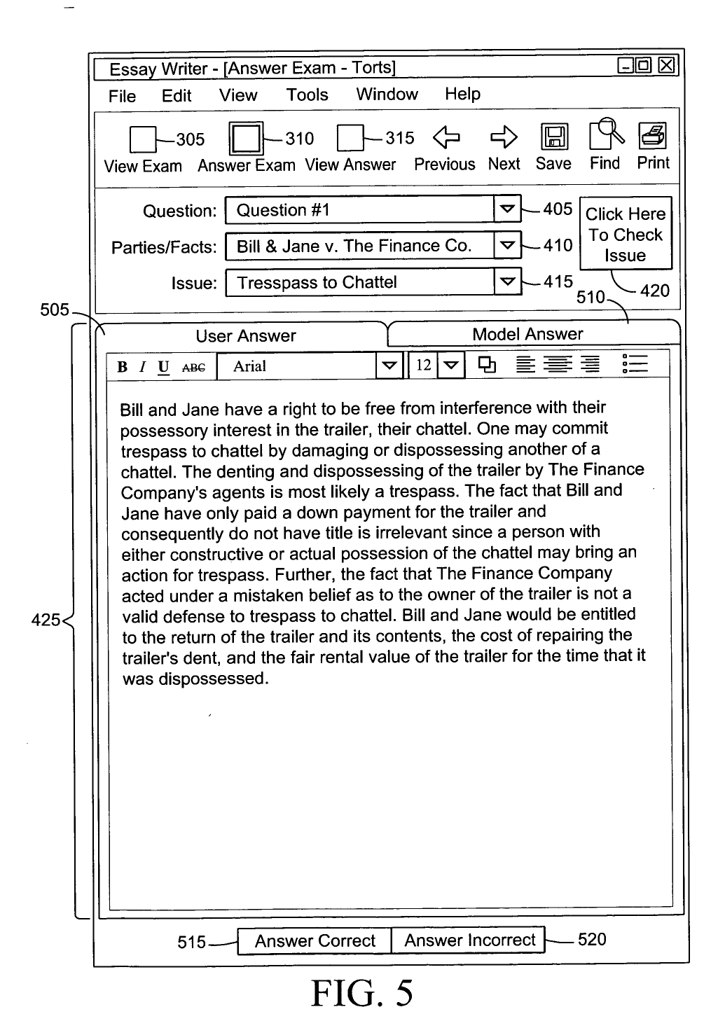

FIG. 5 illustrates one embodiment of a sample screen 500 with the USER ANSWER field 505 enabled. As illustrated, when the USER ANSWER field 505 is enabled, a MODEL ANSWER field 510 is also enabled, as well as an ANSWER CORRECT button 515 and an ANSWER INCORRECT button 520. In some embodiments, the MODEL ANSWER field 510 contains a partial model answer to the essay question prepared in advance by one or more qualified instructors and stored in the database 140. The partial model answer is related to the issue correctly identified by the user, as described above. Therefore, after the user has entered a partial response to the essay question, the user can view the MODEL ANSWER field 510 to compare the user's partial response to the partial model answer. In some embodiments, the user can then make a self-determination as to whether the user's partial response is correct.

Referring again to FIG. 2, this process is illustrated at step 240, in which a determination is made as to whether the user's partial response to the essay question is correct. In some embodiments, the examination module 135 can make this determination automatically by employing any suitable algorithm for evaluating the user's partial response. A number of such algorithms have been developed and are known and understood by those of ordinary skill in the art.

In other embodiments, the examination module 135 can make the determination at step 240 by receiving an appropriate input from the user. For example, if the user determines that the user's partial response is incorrect, the user can activate the ANSWER INCORRECT button 520 and, in a step 245, the user is prompted to try again. In some embodiments, this process can be repeated until the user provides a correct partial response, and activates the ANSWER CORRECT button 515. Then, in a step 250, the user's partial response is stored in the database 140.

In a step 255, a determination is made as to whether the user is finished answering the essay question. In some embodiments, this determination is made automatically by evaluating whether the user has successfully identified every issue presented by the question and provided appropriate partial responses. In other embodiments, the determination is made by receiving an input from the user, such as, for example, a response to a prompt inquiring as to whether the user wishes to continue with the examination.

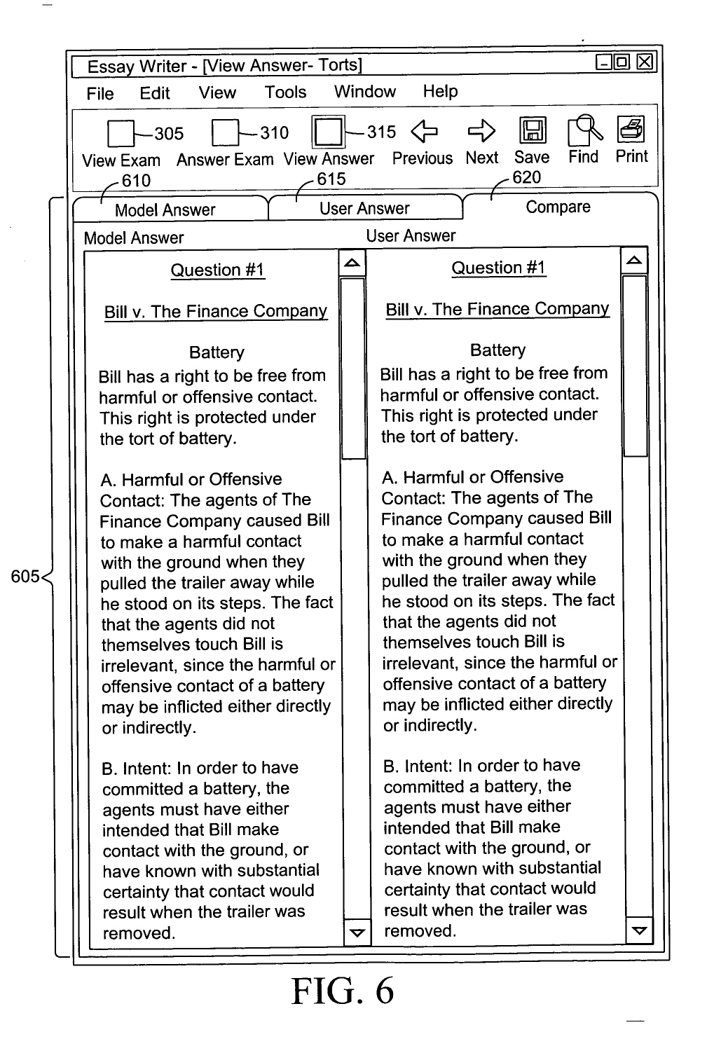

In a step 260, a determination is made as to whether the user desires to view a complete answer to the selected essay question. If not, then in a step 270, the process 200 ends. Otherwise, in a step 265, a complete answer is displayed to the user before the process 200 ends. FIG. 6 illustrates one embodiment of a sample screen 600 displaying a complete answer. As illustrated, when the VIEW ANSWER button 315 is activated, the screen 600 comprises a display frame 605 having a MODEL ANSWER tab 610, a USER ANSWER tab 615, and a COMPARE tab 620.

When the user selects the MODEL ANSWER tab 610, a complete model answer is displayed in the display frame 605. In some embodiments, the complete model answer is prepared in advance by one or more qualified instructors and stored in the database 140. The complete model answer preferably comprises a plurality of partial model answers, organized by issue.

When the user selects the USER ANSWER tab 615, the user's complete response to the essay question is displayed in the display frame 605. In some embodiments, the user's complete response comprises a plurality of the user's partial responses previously stored in the database 140, as described above. The format of the user's complete response preferably parallels the format of the complete model answer to facilitate side-by-side comparison of the user's complete response with the complete model answer. In some embodiments, the user's complete response is formed by combining the user's partial responses and organizing them by issue in the same order as the complete model answer. This format enables the user to perform an issue-by-issue comparison of the user's response with the complete model answer, as described below.

When the user selects the COMPARE tab 620, the complete model answer and the user's complete response are displayed together in the display frame 605, as shown in FIG. 6. In the illustrated embodiment, the complete model answer and the user's complete response are displayed in side-by-side comparison windows within the display frame 605 to allow the user to readily compare the user's complete response to the complete model answer.

As those skilled in the art will appreciate, the sample screens illustrated in FIGS. 3-6 can be displayed in many different ways. For example, the side-by-side comparison windows shown in FIG. 6 can be arranged in a top/bottom configuration, rather than a left/right configuration. As another example, the selection boxes illustrated in FIG. 4 can be implemented as lists with radio buttons, as opposed to drop-down menus. Many other variations are possible, and are within the scope of the present application.

The above-described systems and methods for assisting users to prepare for essay examinations comprise an ordered listing of executable instructions for implementing logical functions. The ordered listing can be embodied in any computer-readable medium for use by, or in connection with, a computer-based system that can retrieve the instructions and execute them. In the context of this application, the computer-readable medium can be any means that can contain, store, communicate, propagate, transmit or transport the instructions. For example, the computer readable medium may comprise, but is not limited to, an electronic, magnetic, optical, electromagnetic, or infrared system, apparatus, or device.

An illustrative, but non-exhaustive list of computer-readable media can include an electronic medium, such as an electrical connection having one or more wires; an optical medium, such as an optical fiber or a portable compact disc read-only memory (CDROM); or a magnetic medium, such as a portable computer disk, a random access memory (RAM), a read-only memory (ROM), an erasable programmable read-only memory (EPROM) or a flash memory. It is also possible to use paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

What is claimed is:

1. A method of assisting a user to prepare for an essay examination comprising:
presenting the user with an essay question;
prompting the user to identify an issue raised by the essay question until the user correctly identifies an issue raised by the essay question;
enabling the user to provide a partial response to the essay question, the partial response being related to the identified issue;
enabling the user to evaluate whether the partial response is correct by comparing the partial response to a partial model answer related to the identified issue;
displaying the user's complete response to the essay question, the complete response comprising a plurality of the user's partial responses organized by issue; and
enabling the user to compare the user's complete response to a complete model answer comprising a plurality of partial model answers organized by issue.

2. The method of claim 1, wherein the essay question is prepared in advance by one or more instructors and stored in a database.

3. The method of claim 1, wherein prompting the user to identify an issue raised by the essay question comprises presenting the user with a list of possible issues raised by the essay question.

4. The method of claim 3, wherein the list of possible issues raised by the essay question includes at least one incorrect answer.

5. The method of claim 4, wherein the list of possible issues is prepared in advance by one or more instructors and stored in a database.

6. The method of claim 3, wherein the list of possible issues is presented to the user in a selection box comprising a drop-down menu.

7. The method of claim 1, wherein the partial model answers and the complete model answer are prepared in advance by one or more instructors and stored in a database.

8. The method of claim 1, further comprising storing the user's partial response in a database.

9. The method of claim 1, wherein the user's complete response is formed by combining the user's partial responses and organizing them by issue in the same order as the complete model answer.

10. The method of claim 1, wherein enabling the user to compare the user's complete response to a complete model answer comprises simultaneously displaying the user's complete response and the complete model answer.

11. The method of claim 10, wherein the user's complete response and the complete model answer are simultaneously displayed in side-by-side comparison windows.

12. A database configured to cooperate with an examination module executed by a processor to assist a user in preparing for an essay examination, the database comprising:
at least one sample essay question;
a list of possible issues raised by each sample essay question, wherein the list of possible issues includes at least one incorrect answer;
a plurality of partial model answers to each sample essay question, wherein each partial model answer relates to an issue raised by the corresponding sample essay question;
a complete model answer to each sample essay question, wherein each complete model answer comprises the plurality of partial model answers to the corresponding sample essay question, organized by issue.

13. The database of claim 12, wherein each sample essay question is prepared by one or more instructors.

14. The database of claim 12, wherein the list of possible issues raised by each sample essay question is prepared by one or more instructors.

15. The database of claim 12, wherein the plurality of partial model answers to each sample essay question is prepared by one or more instructors.

16. A machine readable medium comprising machine readable instructions for causing a computer to perform a method comprising:
presenting the user with an essay question;
prompting the user to identify an issue raised by the essay question until the user correctly identifies an issue raised by the essay question;
enabling the user to provide a partial response to the essay question, the partial response being related to the identified issue;
enabling the user to evaluate whether the partial response is correct by comparing the partial response to a partial model answer related to the identified issue;
displaying the user's complete response to the essay question, the complete response comprising a plurality of the user's partial responses organized by issue; and
enabling the user to compare the user's complete response to a complete model answer comprising a plurality of partial model answers organized by issue.

17. The machine readable medium of claim 16, wherein the essay question is prepared in advance by one or more instructors and stored in a database.

18. The machine readable medium of claim 16, wherein prompting the user to identify an issue raised by the essay question comprises presenting the user with a list of possible issues raised by the essay question.

19. The machine readable medium of claim 16, wherein the partial model answer is prepared in advance by one or more instructors and stored in a database.

20. The machine readable medium of claim 16, wherein enabling the user to compare the user's complete response to a complete model answer comprises simultaneously displaying the user's complete response and the complete model answer.
